(19) United States
(12) Patent Application Publication
(10) Pub. No.: US 2005/0225997 A1
(43) Pub. Date: Oct. 13, 2005

(54) Headlight for motor vehicle

(76) Inventor: Jack Lin, Chong Ho City (TW)

Correspondence Address: Jack LIN, P.O. Box 10-69, Chong Ho,, Taipei, 235, TW

(21) Appl. No.: 10/821,597

(22) Filed: Apr. 8, 2004

(51) Int. Cl. F21V 7/00

(52) U.S. Cl. 362/514

(57) ABSTRACT

A headlight for motor vehicle includes a base, a light device disposed on the base and having two light members located at different locations relative to the base, to generate and provide high beam and low beam respectively. A controlling device may be used for controlling the light members to selectively generate and provide the high beam and the low beam respectively, without moving the light members relative to the reflector or the vehicle. The light device includes a cover to shield the light members, or two tubes coupled to the light members for light exciting purposes.

### BACKGROUND OF THE INVENTION

1. Field of the Invention

The present invention relates to a headlight, and more particularly to a headlight for motor vehicles having two light members for providing high beam and low beam respectively without moving the light members relative to the vehicles.

2. Description of the Prior Art

Typical headlights for motor vehicles are provided for attaching to front portions of vehicles, and comprise a light member to be moved relative to a reflector, to change the light beams for the vehicles.

For example, U.S. Pat. No. 5,971,574 to Taniuchi et al. discloses one of the typical headlights comprising an actuator for moving a light member relative to a reflector in an inclined slope, to change the light beams for the vehicles.

U.S. Pat. No. 6,300,718 to Taniuchi et al. discloses another typical headlight also comprising an actuator or a solenoid for moving a light member relative to a reflector, to change the light beams for the vehicles.

U.S. Pat. No. 6,325,528 to Wittmeier et al. discloses a further typical headlight also comprising an electromagnetic actuating device for moving a light member relative to a reflector, to change the light beams for the vehicles.

U.S. Pat. No. 6,428,187 to Shin discloses a still further typical headlight also comprising a solenoid actuating device for moving a light member relative to a reflector, to change the light beams for the vehicles.

In all of the typical headlights for vehicles, an actuator or a solenoid or an electromagnetic actuating or moving device is required to be provided for moving the light member relative to the reflector, in order to change the light beams for the vehicles.

However, a complicated configuration and a number of elements are required to be provided and assembled together, and will thus greatly increase the volume and the manufacturing cost for the conventional headlights for motor vehicles.

In addition, the light members will be frequently actuated or moved relative to the reflector, in order to change the light beams for the vehicles, such that the electric elements will be easily damaged or worn out.

The present invention has arisen to mitigate and/or obviate the afore-described disadvantages of the conventional headlights for motor vehicles.

### SUMMARY OF THE INVENTION

The primary objective of the present invention is to provide a headlight for motor vehicle including two light members for providing high beam and low beam respectively without moving the light members relative to the vehicles.

In accordance with one aspect of the invention, there is provided a headlight for motor vehicle, comprising a base, a light device provided on the base, and including two light members for generating and providing high beam and low beam respectively, and a controlling device for controlling the light members to selectively generate and provide high beam and low beam respectively, without moving the light members relative to such as the reflector of the vehicle.

The light device includes a cover engaged onto the light members, to cover and to shield the light members. The light device includes two tubes coupled to the light members respectively, for light exciting purposes. The light device includes two pairs of cables coupled to the light members respectively, for coupling the light members to electric power source respectively.

The controlling device is coupled to the light device to control and actuate the light members of the light device. The control device includes at least one stabilizer coupled to the light members of the light device, to stabilize the light members. The light members of the light device may be located at different locations relative to the base of the light device, to generate the high beam and the low beam respectively.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram of a headlight for motor vehicle in accordance with the present invention;

FIG. 2 is a plan view of the headlight for the motor vehicle;

FIG. 3 is a perspective view of the headlight for the motor vehicle;

FIG. 4 is a cross sectional view of the headlight of the motor vehicle; and

FIGS. 5, 6 are perspective views illustrating the operation of the headlight for motor vehicle.

### DETAILED DESCRIPTION OF THE PREFERRED EMBODIMENT

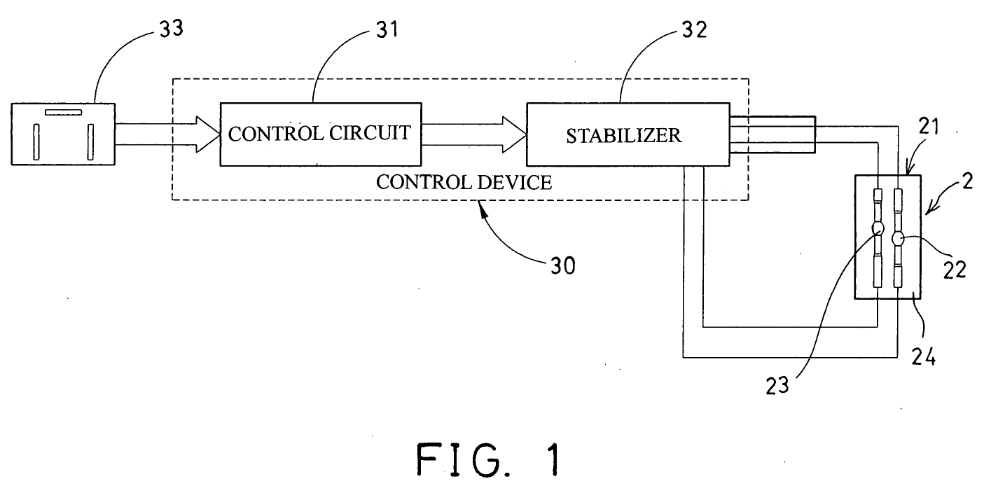

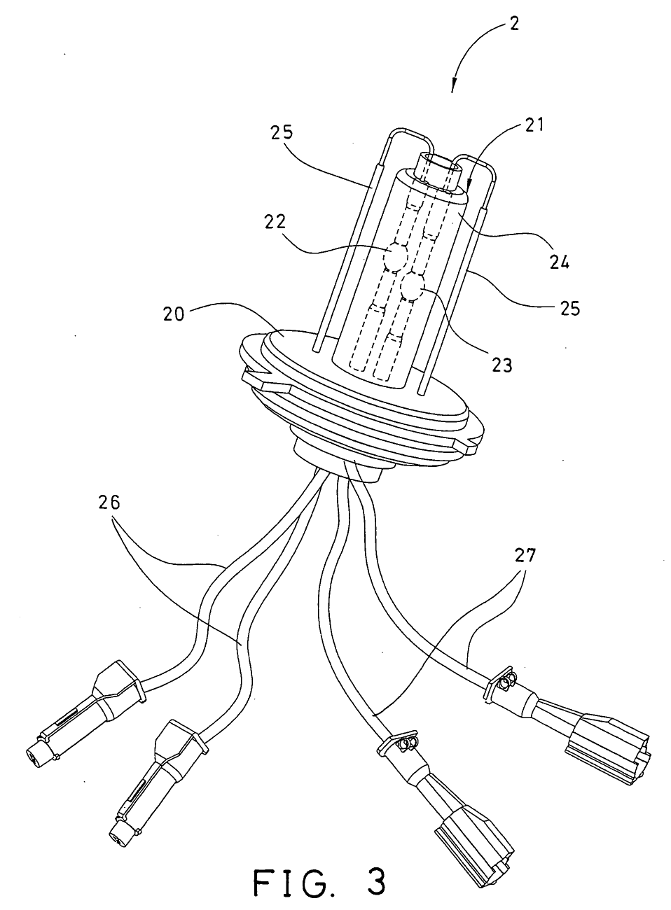

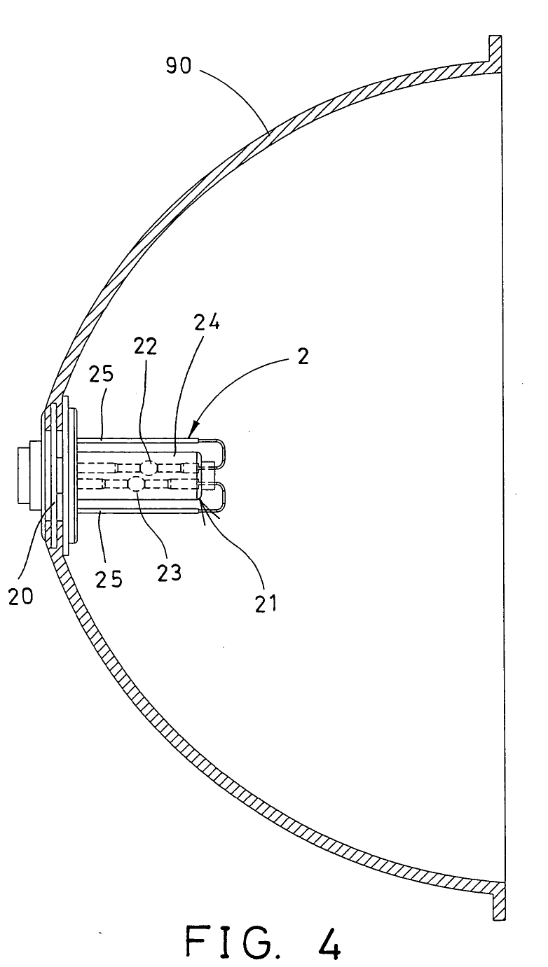

Referring to the drawings, and initially to FIGS. 1-4, a headlight 2 for motor vehicle in accordance with the present invention comprises a socket or a base 20 for attaching to the motor vehicle, such as for attaching to the reflector 90 of the motor vehicle (FIG. 4), and a light device 21 provided on or attached or secured to the base 20 for generating light beams for the motor vehicle.

The light device 21 includes two light members 22, 23 for generating low beam and high beam for the motor vehicle respectively, and a transparent cover 24 engaged onto the light members 22, 23, to enclose and to cover and to shield the light members 22, 23. It is preferable that the cover 24 is made of glass materials, such as quartz glass materials, or the like.

The light device 21 may further include two tubes 25 made of such as china or porcelain or ceramic materials, and coupled to the light members 22, 23 respectively, and disposed beside the light members 22, 23 respectively, and preferably disposed outside the cover 24, for such as light exciting purposes, or for exciting the light members 22, 23 to generate light beams.

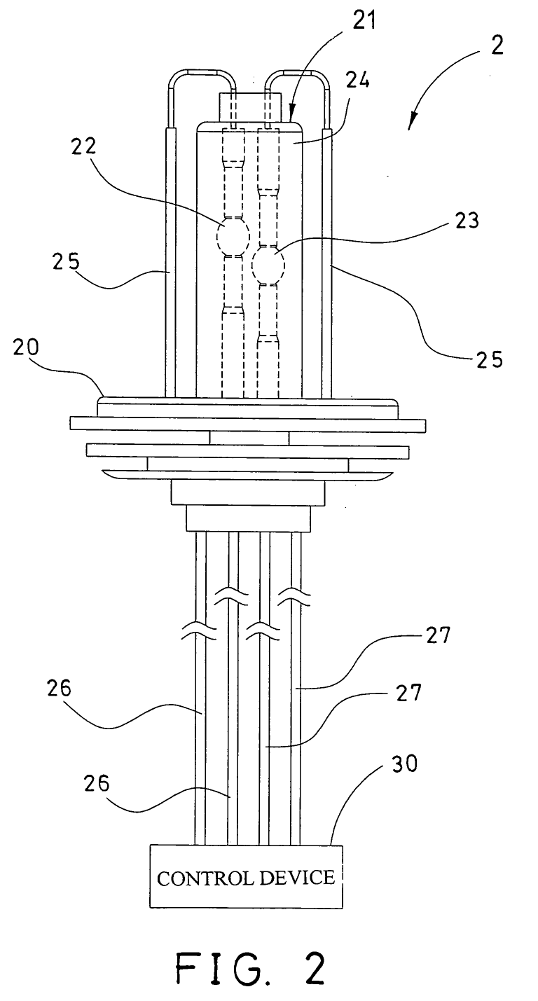

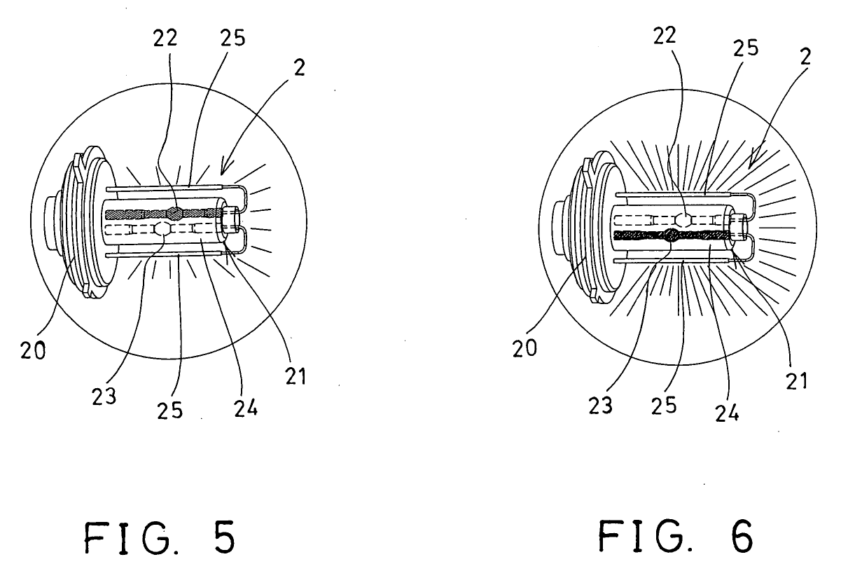

The light device 21 further includes two pairs of cables 26, 27 coupled to the light members 22, 23 respectively, and coupled to a control device 30 (FIGS. 1, 2), for allowing the light members 22, 23 to be controlled or actuated or operated by the control device 30 respectively, and thus for allowing the light members 22, 23 to be actuated or energized to generate or to provide low beam and high beam respectively (FIGS. 5, 6), for example.

As shown in FIG. 1, the control device 30 includes a control circuit 31 for operating or controlling or actuating or energizing the light members 22, 23 respectively, and one or more stabilizers 32 coupled between the control circuit 31 and the light device 21, to stabilize the light members 22, 23. The control device 30 may be coupled to a socket 33 of the vehicle, for coupling to the electric power source of the vehicle.

In operation, as shown in FIGS. 5 and 6, the light members 22, 23 may be actuated or energized to generate or to provide low beam and high beam respectively or selectively, by the control circuit 31 of the control device 30, without moving the light members 22, 23 of the light device 21 relative to the reflector 90 of the vehicle.

As shown in FIG. 4, the light members 22, 23 of the light device 21 may be located at different locations or positions relative to the base 20 and/or relative to the reflector 90 of the vehicle, such that the light beams generated by the light members 22, 23 of the light device 21 may be formed as low beam and high beam respectively.

It is to be noted that the light members 22, 23 may be actuated or energized respectively or selectively by the control circuit 31 of the control device 30, to generate or to provide low beam and high beam respectively, and the light members 22, 23 of the light device 21 are not required to be moved relative to the reflector 90 of the vehicle, such that the headlight 2 may include a greatly simplified configuration and a greatly reduced manufacturing cost.

Accordingly, the headlight in accordance with the present invention includes two light members for providing high beam and low beam respectively without moving the light members relative to the vehicles.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A headlight for motor vehicle, comprising:
a base,
a light device provided on said base, and including two light members for generating and providing high beam and low beam respectively, and
means for controlling said light members to selectively generate and provide high beam and low beam respectively.

2. The headlight as claimed in claim 1, wherein said light device includes a cover engaged onto said light members, to cover and to shield said light members.

3. The headlight as claimed in claim 1, wherein said light device includes two tubes coupled to said light members respectively, for light exciting purposes.

4. The headlight as claimed in claim 1, wherein said light device includes two pairs of cables coupled to said light members respectively, for coupling said light members to electric power source respectively.

5. The headlight as claimed in claim 1, wherein said controlling means includes a control device coupled to said light device to control said light members of said light device.

6. The headlight as claimed in claim 5, wherein said control device includes at least one stabilizer coupled to said light members of said light device, to stabilize said light members.

7. The headlight as claimed in claim 1, wherein said light members of said light device are located at different locations relative to said base of said light device.
